(19) United States
(12) Patent Application Publication
(10) Pub. No.: US 2010/0153507 A1
(43) Pub. Date: Jun. 17, 2010

(54) SYSTEMS AND METHODS FOR PROCESSING ELECTRONIC DATA

(75) Inventors: Shaohong Wei, Sunnyvale, CA (US); Anthony James, San Jose, CA (US); Todd A. Nelson, Los Altos, CA (US)

Correspondence Address: SCHWEGMAN, LUNDBERG & WOESSNER, P.A., P.O. BOX 2938, MINNEAPOLIS, MN, 55402, US

(73) Assignee: Fortinet, Inc., Sunnyvale, CA (US)

(21) Appl. No.: 12/640,583

(22) Filed: Dec. 17, 2009

Related U.S. Application Data
(62) Division of application No. 11/252,973, filed on Oct. 17, 2005.
(60) Provisional application No. 60/685,124, filed on May 27, 2005.

(51) Int. Cl. G06F 15/16

(52) U.S. Cl. 709/206

(57) ABSTRACT

A method of processing electronic data includes receiving electronic data, and scanning at least a portion of the electronic data against a first signature, wherein the first signature is not data-type dependent. A method of processing electronic data includes receiving electronic data to be scanned, identifying a portion of the electronic data, wherein the portion is represented as an object, and assigning one or more procedures to scan the portion based at least in part on the object. A system for processing electronic data includes an input for receiving electronic data, a processor configured for identifying one or more portions of the electronic data, each of the one or more portions represented as a typed object, and a buffer configured to store data associated with no more than one object at a time.

### RELATED APPLICATION DATA

This application claims priority to U.S. patent application Ser. No. 11/252,973 filed on Oct. 17, 2005 entitled SYSTEMS AND METHODS FOR PROCESSING ELECTRONIC DATA, which claims priority to U.S. Provisional Patent Application 60/685,124 filed on May 27, 2005, which applications are incorporated herein by reference in their entirety.

### BACKGROUND

1. Field

The field of the application relates to computer network and computer systems, and more particularly, to systems and methods for processing electronic data communicated between computers or communication devices.

2. Background

The generation and spread of malware is a major problem in computer systems and computer networks. A computer virus is a form of malware that is capable of attaching to other programs, replicating itself, and/or performing unsolicited or malicious actions on a computer system. Other examples of malware include spyware, worms, and trojans. Malware may be embedded in email attachments, files downloaded from the Internet, and macros in MS Office files. The damage that can be done by a computer virus may range from mild interference with a program, such as a display of unsolicited messages or graphics, unauthorized collection and transmission of personal information, to complete destruction of data on a user's hard drive or server.

To provide protection from viruses, most organizations have installed virus scanning software on computers in their network. Existing content inspection software detects virus by first determining a type of data that is being received. Based on the type of data, the inspection software then scans the data against a signature that is directed to a specific type of data. For example, if the data that is being scanned is a word file, the content inspection software then scans the word file against one or more signatures that are dedicated for scanning of word files. Such technique allows the content inspection software to detect virus efficiently because each signature is used to scan a dedicated type of data (and data of a different type is not scanned against such data-type dependent signature). However, a virus may be contained in files of different types. For example, a virus may be contained in a word file, and the same virus may be contained in a script file. In such cases, dedicating a signature for scanning of word files, for example, would cause the virus not to be detected in the event that the same virus is also embedded in a script file.

Another problem with existing content inspection systems is that many such systems include a working buffer for storing data that is being processed. The working buffer is used to store data that are being scanned. Currently, much system resources may be utilized to keep track with, and organize, data that are in the working buffer. For example, in the case of email messages, current methodology requires storing the entire encapsulation unit (an entire email message) in a buffer, which consumes large amounts of memory, and introduces latency downstream.

### SUMMARY

In accordance with some embodiments, a method of processing electronic data includes receiving electronic data, and scanning at least a portion of the electronic data against a first signature, wherein the first signature is not data-type dependent.

In accordance with other embodiments, a computer-program product having a medium, the medium having a set of instructions readable by a processor, wherein an execution of the instructions by the processor causes a method to be performed, the method includes receiving electronic data, and scanning at least a portion of the electronic data against a first signature, wherein the first signature is not data-type dependent.

In accordance with other embodiments, a system for processing electronic data includes a processor configured for receiving electronic data, and scanning at least a portion of the electronic data against a first signature, wherein the first signature is not data-type dependent.

In accordance with other embodiments, a method of processing electronic data includes receiving a first electronic data, the first electronic data having a first data type, scanning the first electronic data against a signature, receiving a second electronic data, the second electronic data having a second data type that is different from the first data type, and scanning the second electronic data against the signature.

In accordance with other embodiments, a computer-program product having a medium, the medium having a set of instructions readable by a processor, wherein an execution of the instructions by the processor causes a method to be performed, the method includes receiving a first electronic data, the first electronic data having a first data type, scanning the first electronic data against a signature, receiving a second electronic data, the second electronic data having a second data type that is different from the first data type, and scanning the second electronic data against the signature.

In accordance with other embodiments, a system for processing electronic data includes a processor configured for receiving a first electronic data, scanning the first electronic data against a signature, receiving a second electronic data, and scanning the second electronic data against the signature, wherein the first electronic data has a first data type, and the second electronic data has a second data type that is different from the first data type.

In accordance with other embodiments, a method of processing encapsulation data includes receiving encapsulation data, identifying a first portion of the encapsulation data, sending the first portion to a buffer for processing, and sending the second portion to the buffer for processing after the first portion has been processed.

In accordance with other embodiments, a computer-program product having a medium, the medium having a set of instructions readable by a processor, wherein an execution of the instructions by the processor causes a method to be performed, the method includes receiving encapsulation data, identifying a first portion of the encapsulation data, identifying a second portion of the encapsulation data, sending the first portion to a buffer for processing, and sending the second portion to the buffer for processing after the first portion has been processed.

In accordance with other embodiments, a system for processing electronic data includes a processor configured for receiving encapsulation data, identifying a first portion of the encapsulation data, identifying a second portion of the encapsulation data, sending the first portion to a buffer for processing, and sending the second portion to the buffer for processing after the first portion has been processed.

In accordance with other embodiments, a method of processing electronic data includes receiving electronic data to be scanned, identifying a portion of the electronic data, wherein the portion is represented as an object, and assigning one or more procedures to scan the portion based at least in part on the object.

In accordance with other embodiments, a computer-program product having a medium, the medium having a set of instructions readable by a processor, wherein an execution of the instructions by the processor causes a method to be performed, the method includes receiving electronic data to be scanned, identifying a portion of the electronic data, wherein the portion is represented as an object, and assigning one or more procedures to scan the portion based at least in part on the object.

In accordance with other embodiments, a system for processing electronic data includes a processor configured for receiving electronic data to be scanned, identifying a portion of the electronic data, wherein the portion is represented as an object, and assigning one or more procedures to scan the portion based at least in part on the typed object.

In accordance with other embodiments, a system for processing electronic data includes an input for receiving electronic data, a processor configured for identifying one or more portions of the electronic data, each of the one or more portions represented as a typed object, and a buffer configured to store data associated with no more than one object at a time.

Other aspects and features of the embodiments will be evident from reading the following description of the embodiments.

### BRIEF DESCRIPTION OF THE DRAWINGS

The drawings illustrate the design and utility of embodiments of the application, in which similar elements are referred to by common reference numerals. In order to better appreciate how advantages and objects of various embodiments are obtained, a more particular description of the embodiments are illustrated in the accompanying drawings. Understanding that these drawings depict only typical embodiments of the application and are not therefore to be considered limiting its scope, the embodiments will be described and explained with additional specificity and detail through the use of the accompanying drawings.

FIG. 1 illustrates a block diagram of an electronic data processing system having a module in accordance with some embodiments;

FIG. 2A illustrates a method performed by the module of FIG. 1 in accordance with some embodiments;

FIG. 2B illustrates a method performed by the module of FIG. 1 in accordance with other embodiments;

FIG. 2C illustrates a method performed by the module of FIG. 1 in accordance with other embodiments;

FIG. 3 illustrates a block diagram of an electronic data processing system having a module in accordance with other embodiments;

FIG. 4 illustrates a method of processing electronic data performed by the module of FIG. 3 in accordance with some embodiments;

FIG. 5 illustrates an example of an email data structure in accordance with some embodiments;

FIG. 6 illustrates an example of associating different portions of an email to different objects;

FIG. 7A illustrates an example of assigning one or more procedures to scan data in accordance with some embodiments;

FIG. 7B illustrates an example of assigning one or more procedures to can data in accordance with other embodiments;

FIG. 8 illustrates a block diagram of a module in accordance with some embodiments; and

FIG. 9 illustrates a diagram of a computer hardware system that can be used to perform various functions described herein in accordance with some embodiments.

### DETAILED DESCRIPTION

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of specific embodiments. They are not intended as an exhaustive description of the invention or as a limitation on the scope of the invention. In addition, an illustrated embodiment may not show all aspects or advantages. An aspect or an advantage described in conjunction with a particular embodiment is not necessarily limited to that embodiment and can be practiced in any other embodiments, even if not so illustrated or described.

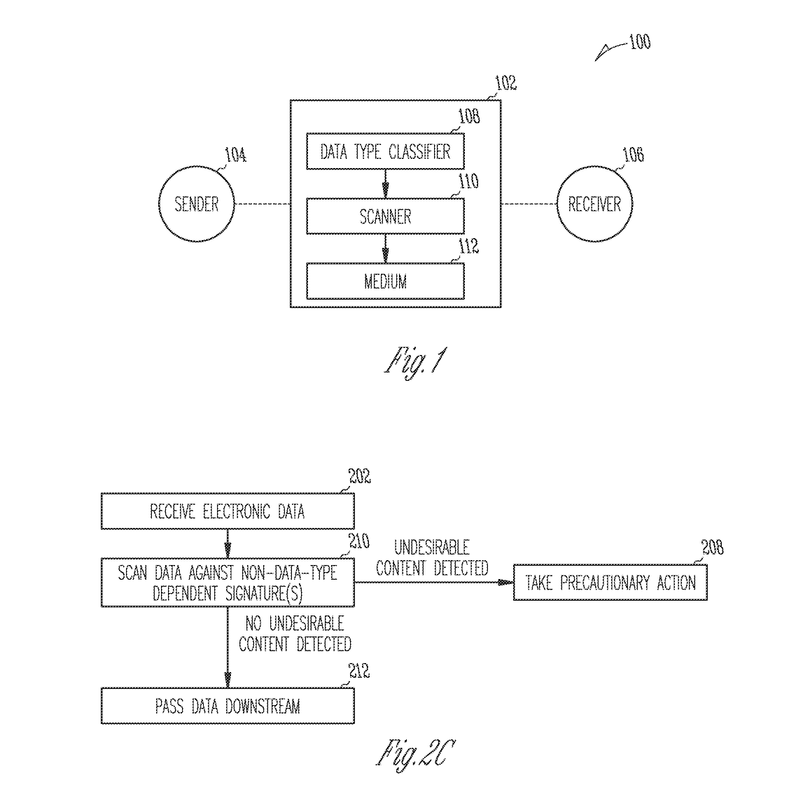

FIG. 1 illustrates a block diagram of an electronic data processing system 100 which includes a module 102 in accordance with some embodiments. Module 102 is communicatively coupled between sender 104 and receiver 106. However, in other embodiments, module 102 can be a part of, or be integrated with, sender 104, receiver 106, or both. During use, sender 104 transmits electronic data (packet) to module 102. Module 102 receives the transmitted data, and perform one or more procedures using the data in accordance with the embodiments described herein. In some embodiments, the data received by module 102 is email data. In other embodiments, the data received by module 102 can be data associated with web page, file transfer, communication exchange (e.g., protocol negotiation between devices, streaming media including VoIP), or any of other data encapsulation. As used in this specification, the term “sender” should not be limited to a human, and can include a server or other types of devices (software and/or hardware) that can receive and/or transmit information. Also, as used in this specification, the term “receiver” should not be limited to a human receiver, and can include a server or other types of devices (software and/or hardware) that can store, receive, and/or transmit information.

In the illustrated embodiments, the module 102 is configured (e.g., designed, programmed, and/or constructed) to determine whether electronic data received is associated with a content desired to be detected, based on a signature. As used in this specification, the term “signature” refers to a content inspection data, such as a virus signature, which may be a spammer identification, a URL, or a spy-ware program identification, or any information that can be used in a procedure to determine content desired to be detected (e.g., malicious content). In some embodiments, the signature is transmitted from an update station (not shown), such as a remote server or computer, in response to the module's 102 request to download such signature. For example, the module 102 can be configured to periodically download updated signatures from one or more update stations (as in a “PULL” technique). In other embodiments, the update station(s) is configured to transmit signatures to the module 102 not in response to a request from the module 102 (as in a “PUSH” technique). In further embodiments, the signatures can be input into module 102 by a user.

In the illustrated embodiments, module 102 includes a data type classifier 108, a scanner 110, and a medium 112 for storing signatures. The data type classifier 108 is configured to classify data received by the module 102. For example, the data type classifier 108 may classify received data to be a word file, a text file, a compressed file, an archive file, a html file, an acrobat file, or a script file. The scanner 110 is configured to scan received data to determine if it contains content desired to be detected, such as a virus or other malicious content. In some embodiments, the scanner 110 scans the received data against one or more signatures based on the type of received data as determined by the data type classifier 108. In such cases, the signature(s) is data-type dependent. For example, if data type classifier 108 determines the received data to be a word file, then the scanner 110 may scan the data against signatures S1, S2, and S3, which are dedicated for use to scan word file. Alternatively, if data type classifier 108 determines the received data to be a script file, then the scanner 110 may scan the data against signatures, S4 and S5, which are dedicated for use to scan script file. Alternatively, or additionally, the scanner 110 scans the received data against one or more signatures independent of the type of received data. In such cases, the signature(s) is not data-type dependent (i.e., the signature(s) is non-data-type dependent). As used in this specification, the term “non-data-type dependent signature” refers to a signature that is used to scan two or more different types of data. In some cases, a data may be classified as an “unknown” type if it cannot be classified as one of other prescribed types. In some embodiments, the types of data that use such non-data-type dependent signature(s) may be specifically prescribed during a configuration of the module 102. Alternatively, the non-data-type signatures may be applied for all incoming electronic data, regardless of the type of received data. The signature(s) can be stored in the storage medium 112, which can be, for example, a memory, or a disk, and is accessible by the scanner 110.

Although the module 102 has been described as having the data type classifier 108, the scanner 110, and the storage medium 112, in alternative embodiments, one or more of the components of the module 102 can be combined with another component of the module 102. Also, in further embodiments, the module 102 needs not include all of the components 108-112.

In some embodiments, the module 102, or any of the components of the module 102, can be implemented using software. For example, module 102 can be implemented using software that is loaded onto a user's computer, a server, a memory, a disk, a CD-ROM, or any of other mediums. In some cases, module 102 can be implemented as web applications. In alternative embodiments, module 102 can be implemented using hardware. For example, in some embodiments, module 102 includes an application-specific integrated circuit (ASIC), such as a semi-custom ASIC processor or a programmable ASIC processor. ASICs, such as those described in Application-Specific Integrated Circuits by Michael J. S. Smith, Addison-Wesley Pub Co. (1st Edition, June 1997), are well known in the art of circuit design, and therefore will not be described in further detail herein. In other embodiments, module 102 can also be any of a variety of circuits or devices that are capable of performing the functions described herein. For example, in alternative embodiments, module 102 can include a general purpose processor, such as a Pentium processor. In other embodiments, module 102 can be implemented using a combination of software and hardware. In some embodiments, module 102 may be implemented as a firewall, a component of a firewall, or a component that is configured to be coupled to a firewall. In other embodiments, module 102 is implemented as a component of a gateway (or gateway product, such as an anti-virus module). In further embodiments, instead of being a component of gateway, module 102 can be a separate component that is coupled to gateway 12. In other embodiments, module 102 can be a gateway product by itself, and can be implemented at any point along a communication path between sender 104 and receiver 106. In further embodiments, module 102 could be used in a switch, such as a security switch.

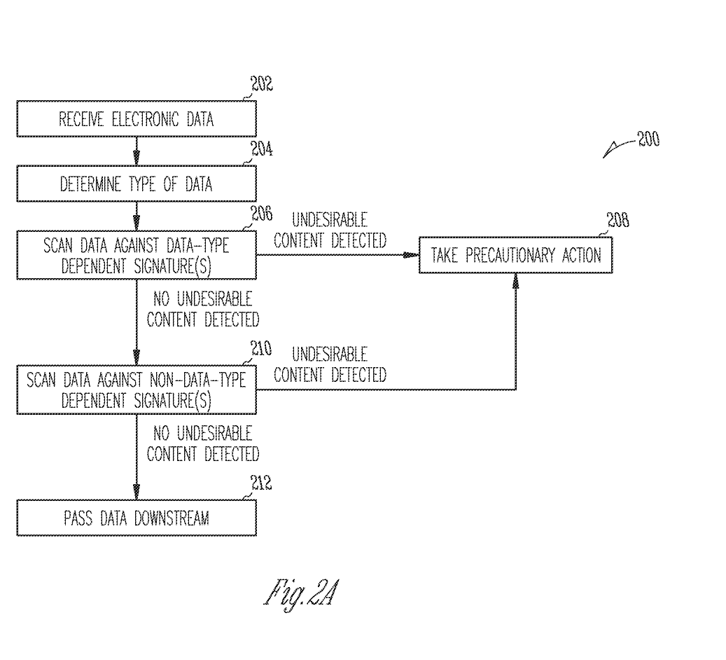

Having described the module 102, a method 200 of using the module 102 to process electronic data in accordance with some embodiments will now be described with reference to FIG. 2A. First, the module 102 receives electronic data (step 202). By means of non-limiting examples, such electronic data can be that associated with a web page, an email, a picture, a voicemail, IM chat, a peer-to-peer communication, or any of other data encapsulation, wherein at least a portion of which may or may not contain content desired to be detected (e.g., a virus or any of other undesirable content). As used in this specification, the term “data encapsulation” or “encapsulation” refers to a packaging of data associated with one or more data items. For example, an email may be an encapsulation of an email body and an attachment. As another example, a web page may be an encapsulation of a script and a picture.

The module 102 can receive the electronic data from any of a variety of sources. For example, the module 102 can receive the electronic data from the sender 104 who sends the electronic data to the module 102 through the internet. Alternatively, the module 102 can receive electronic data by a person, who inputs the electronic data into the module 102, e.g., by loading the electronic data into the module 102 using a disk, a CD ROM, a memory, and the like.

After the module 102 received the electronic data, the module 102 then determines the type of the received data (Step 204). Such can be performed by the data type classifier 108 of the module 102. Techniques for determining data type are well known in the art, and therefore, will not be described in further details. In some embodiments, the data type classifier 108 classifies received data as anyone of the following types: VBScript file type, batch file type, visual basic application file type, command file type, windows executable file type, install shield compressed file type, winzip compressed file type, Gzip compressed file type, Bzip compressed file type, Bzip 2 compressed file type, tape archive file type, hypertext markup language file type, word document file type, hypertext application type, text file type, compressed archive file type, windows help file type, compressed archive file type, acrobat portable document format, or PHP script. In other embodiments, the data type classifier 108 classifies received data as one of other types of data, such as a customized file type.

Next, the scanner 110 of the module 102 scans the received electronic data against one or more signatures stored in the medium 112 based on the determined type of the received data (Step 206). In the illustrated embodiments, data-type dependent signatures are stored and organized in the medium 112 based on data type. For example, signatures S1-S4 may be categorized as 10 “word signatures” that are used to scan word files, while signatures S5 and S6 may be “script signatures” that are used to scan script files. In some embodiments, data-type dependent signature(s) can be based on any of other data types (any of those classified by data type classifier 108). Based on a result of the scanning, the scanner 110 may determine whether the electronic data received is associated with content desired to be detected. In some cases, the scanner 110 may determine, based on its processing of the electronic data, that the electronic data received by the module 102 is associated with a content desired to be detected. For example, the scanner 110 may determine that the received electronic data by the module 102 contains a virus. In such cases, the module 102 then perform one or more precautionary actions (Step 208). For examples, the module 102 may reject the electronic data, may prevent the electronic data from being sent downstream, and/or may send a warning message downstream (e.g., to the receiver 106 to which the electronic data is intended to be transmitted) or upstream.

Alternatively, the scanner 110 may determine, based on its processing of the electronic data, that the electronic data received by the module 102 is not associated with a content desired to be detected. In such cases, the scanner 110 then scans the received electronic data against one or more non-data-type dependent signatures (Step 210). In the illustrated embodiments, a non-data-type dependent signature is a signature that is used to scan the electronic data regardless of the type of electronic data. The non-data-type signatures may be updated in the module 102 by configuring the module 102 to periodically download updated signatures from a station, such as a remote server or computer. Alternatively, the non-data-type-signatures may be updated in the module 102 by configuring the module 102 to receive updated signatures from an update station that transmits such signatures to the module 102 not in response to a request by the module 102 (as in the “PUSH” technique). Scanning received electronic data against non-data-type dependent signature(s) allows the module 102 to detect malicious content, such as a virus, that can be contained in different types of electronic data. In some embodiments, a signature can be both a data-type dependent signature and a non-data-type dependent signature. For example, in some embodiments, a signature can be used as a data-type dependent signature to scan data of a first type, and also be used as a non-data-type dependent signature to scan two or more types of data (wherein a type can be an “unknown” type).

Based on a result of the scanning of the electronic data against the non-data-type dependent signature(s), the scanner 110 may determine whether the electronic data received is associated with content desired to be detected. In some cases, the scanner 110 may determine, based on its processing of the electronic data, that the electronic data received by the module 102 is associated with a content desired to be detected. For example, the scanner 110 may determine that the received electronic data by the module 102 contains a virus. In such cases, the module 102 then perform one or more precautionary actions (Step 208). For example, the module 102 may reject the electronic data, may prevent the electronic data from being sent downstream, and/or may send a warning message downstream (e.g., to the receiver 106 to which the electronic data is intended to be transmitted) or upstream.

Alternatively, the scanner 110 may determine, based on its processing of the electronic data. that the electronic data received by the module 102 is not associated with a content desired to be detected. In such cases, the module 102 then passes the electronic data downstream to the receiver 106 (Step 212).

It should be noted that the order of steps 202-212 in the method 200 is not limited to the embodiments described previously, and that the method 200 can have different order of steps in other embodiments. For example, as shown in FIG. 2B, in alternative embodiments, the received electronic data can be scanned against one or more non-data-type dependent signatures (Step 210) before it is scanned against one or more data-type dependent signatures (Step 204).

Also, in other embodiments, the method 200 needs not include all of the steps described previously. For example, as shown in FIG. 2C, in alternative embodiments, the method 200 does not include the step 204 of determining data type and the step 206 of scanning electronic data against data-type dependent signature(s). In such cases, the scanner 110 is configured to scan electronic data against non-data-type dependent signature(s).

In further embodiments, one or more steps of method 200 can be combined with another step of method 200. Also, in alternative embodiments, a step of method 200 can be further divided into sub-procedures.

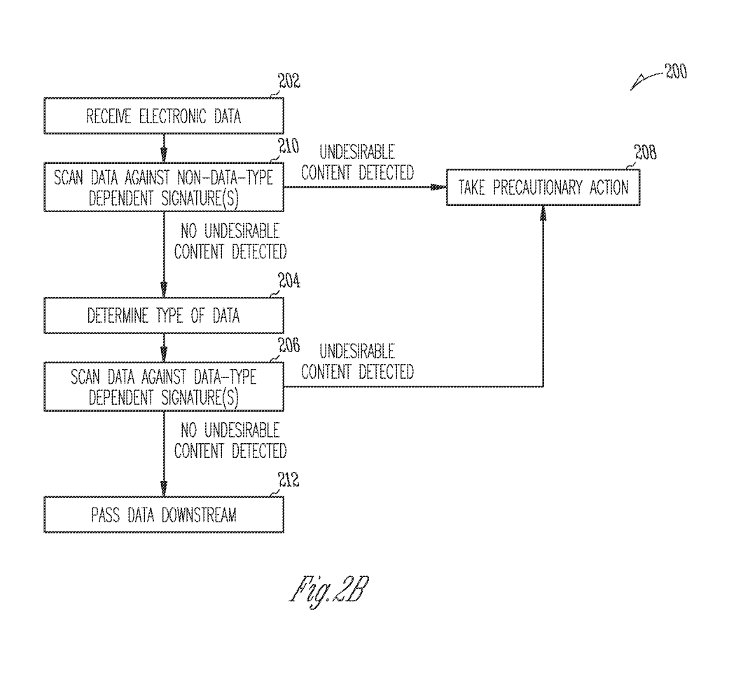

FIG. 3 illustrates a block diagram of an electronic data processing system 300 which includes a module 302 in accordance with other embodiments. Module 302 is communicatively coupled between sender 104 and receiver 106. However, in other embodiments, module 302 can be a part of, or be integrated with, sender 104, receiver 106, or both. During use, sender 104 transmits electronic data (packet) to module 302. Module 302 receives the transmitted, data, and perform one or more procedures using the data in accordance with the embodiments described herein. In some embodiments, the data received by module 302 is email data. In other embodiments, the data received by module 302 can be web page data or data associated with other data encapsulation.

In the illustrated embodiments, the module 302 is configured (e.g., designed, programmed, and/or constructed) to assign one or more procedures for processing received electronic data based on an object that represents (is associated with) the electronic data. The object that is used to represent the electronic data and its use will be described in further detail below.

In the illustrated embodiments, module 302 includes a portion identifier 304, an object assigning module 306, a procedure assigning module 308, and a processing module 310. The portion identifier 304 is configured to identify one or more portions of electronic data received by module 302. For example, if the received data is email data, the portion identifier 304 may identify an email header, an email body, a delimiter, or an attachment. In another example, if the received data is a web page data, the portion identifier 304 may identify an image file, a flash code, javascript, or other items associated with a web page. In some embodiments, the portion identifier 304 may also include a data type classifier, such as the classifier 108 described with reference to the module 102. The data type classifier is configured to classify data received by the module 302. For example, the data type classifier may classify received data to be word file data, text file data, or other types of data. In such cases, the portion identifier 304 is configured to identify one or more portions of received data, and classify the identified portion(s).

The object assigning module 306 is configured to associate a portion of the received electronic data (identified by the portion identifier 304) with an object. As used in this specification, the term “object” refers to data abstraction that has a prescribed set of one or more attributes or properties. In some cases, the attribute(s) allow a device, such as a content inspection device, to recognize or detect the object in received data, and/or to apply scanning procedure(s) to the object. In some embodiments, the number and types of objects are predetermined. In other embodiments, the module 302 includes a user interface, such as a keyboard, that allows a user to define customized objects. Also, in further embodiments, the user interface allows a user to modify or create attribute(s) for object(s).

The procedure assigning module 308 is configured to assign one or more procedures to process an identified portion of the electronic data based on the object representing the identified portion. For example, the procedure assigning module 308 may assign scanning procedures P1 and P2 to scan the identified portion of the electronic data if the object representing the identified portion is O1, and may assign scanning procedure P3 to scan the identified portion if the object representing the identified portion is O2. In such cases, the procedure(s) is assigned based on an identifier attribute of an object. In some embodiments, the procedure assigning module 308 can assign a null procedure for the identified portion, thereby causing the portion to be transmitted downstream without being processed. The processing module 310 is configured to perform the procedure(s) assigned by the procedure assigning module 308.

Although the module 302 has been described as having the portion identifier 304, the object assigning module 306, the procedure assigning module 308, and the processing module 310, in alternative embodiments, one or more of the components of the module 302 can be combined with another component of the module 302. Also, in further embodiments, the module 302 needs not include all of the components 304-310.

In some embodiments, module 302, or any of the components of the module 302, can be implemented using software. For example, module 302 can be implemented using software that is loaded onto a user's computer, a server, or other types of storage medium, such as a memory, a disk, or a CD-ROM. In some cases, module 302 can be implemented as web applications. In alternative embodiments, module 302 can be implemented using hardware. For example, in some embodiments, module 302 includes an application-specific integrated circuit (ASIC), such as a semi-custom ASIC processor or a programmable ASIC processor. ASICs, such as those described in Application-Specific Integrated Circuits by Michael J. S. Smith, Addison-Wesley Pub Co. (1st Edition, June 1997), are well known in the art of circuit design, and therefore will not be described in further detail herein. In other embodiments, module 302 can also be any of a variety of circuits or devices that are capable of performing the functions described herein. For example, in alternative embodiments, module 302 can include a general purpose processor, such as a Pentium processor. In other embodiments, module 302 can be implemented using a combination of software and hardware. In some embodiments, module 302 may be implemented as a firewall, a component of a firewall, or a component that is configured to be coupled to a firewall. In other embodiments, module 302 is implemented as a component of a gateway (or gateway product, such as an anti-virus module). In further embodiments, instead of being a component of gateway, module 302 can be a separate component that is coupled to gateway 12. In other embodiments, module 302 can be a gateway product by itself, and can be implemented at any point along a communication path between sender 104 and receiver 106. In further embodiments, module 302 could be used in a switch, such as a security switch.

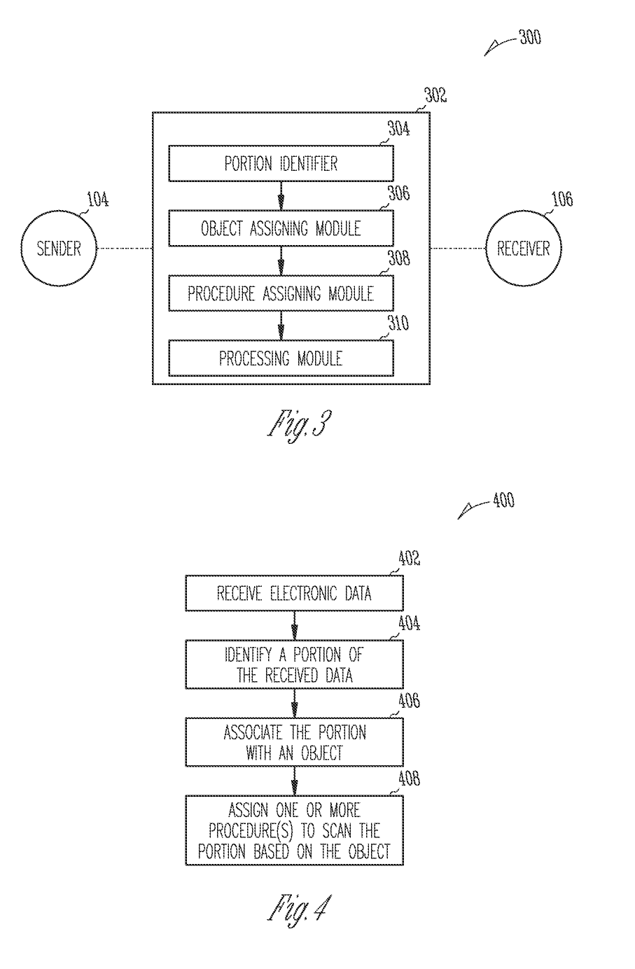

Having described the module 302, a method 400 of using the module 302 to process electronic data in accordance with some embodiments will now be described with reference to FIG. 4. First, the module 302 receives electronic data (step 402). By means of non-limiting examples, such electronic data can be that associated with a web page, an email, a picture, a voicemail, a peer-to-peer communication, or any of other data encapsulation, a portion of which may or may not contain content desired to be detected (e.g., a virus or any of other undesirable content). The module 302 can receive the electronic data from any of a variety of sources. For example, the module 302 can receive the electronic data from the sender 104 who sends the electronic data to the module 102 through the internet. Alternatively, the module 302 can receive electronic data by a person, who inputs the electronic data into the module 302, e.g., by loading the electronic data into the module 302 using a disk, a CD ROM, a memory, and the like.

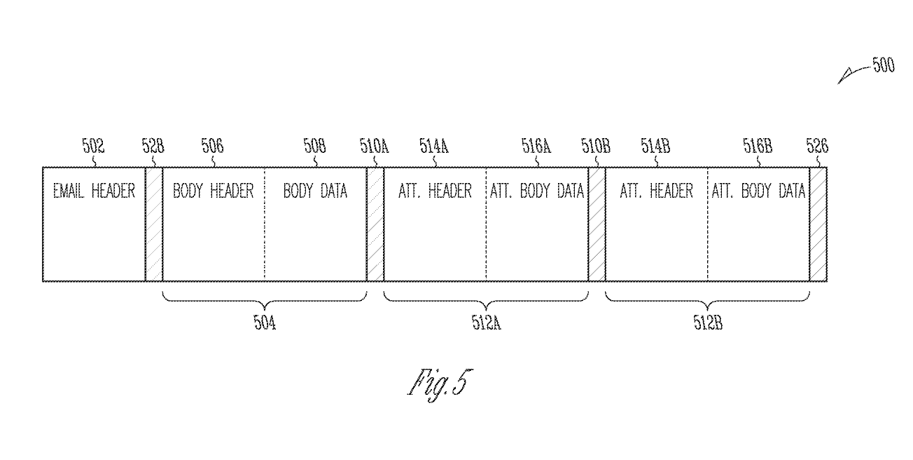

Next, the portion identifier 304 identifies one or more portions of the received electronic data. For the purpose of the following discussion, it will be assumed that the electronic data comprises MIME message. However, in other embodiments, the electronic data can be any of other data encapsulation (e.g., a web page), as discussed. FIG. 5 is a diagram illustrating an email data structure 500 in accordance with some embodiments. As shown in the figure, the email data structure 500 includes an email header 502, an email body 504 having a body header 506 and body data 508, a delimiter 528 separating the email header 502 and the email body 504, attachment data 512 having attachment header 514 and attachment body data 516, delimiter(s) 510 separating the email body 504 and attachment data 512a (or separating different attachment data 512a, 512b), and an end data 526. In other embodiments, the data structure 500 can have different configurations. For example, in other embodiments, the data structure 500 may not include any attachment data 512. In the illustrated embodiments, at step 404, the portion identifier 304 determines whether a portion of the received data is associated with an email header 502, an email body header 506, email body data 508, a delimiter 510, an attachment header 514, attachment body data 516, or an end data 526. Various techniques can be used to identify different portions of email data. In some embodiments, the portion identifier 304 is configured to examine an embedded pattern within the email data to identify the various portions of email data. For example, since email header 502 has a certain prescribed format or configuration, the portion identifier 304 can be configured to search for the portion of the email data that has the prescribed format for the email header, thereby determining the email header 502 in the received electronic data. In other embodiments, the portion identifier 304 can identify a boundary string, thereby determining a beginning and an end of a portion. In such cases, the content of the portion is examined by the portion identifier 304 to determine what is the type of the portion. The following is an example of an email message (in raw form):

```
From: “sender” <sender@sample-sender.com>
To: “receiver” <receiver@sample-receiver.com>
Subject: TEST EMAIL SUBJECT
Date: Fri, 14 Oct 2005 15:36:17 -0700
Message-ID: <ASDOIUEWEFMPWOF.pwei@sample-sender.com>
MIME-Version: 1.0
Conetne-Type: multipart/mixed;
  boundary=“------= NextPart_000_046B_01C5DOD5.04A87ED0”
X-Priority: 3 (Normal)
X-MSMail-Priority: Normal
X-Mailer: Microsoft Outlook IMO, Build 9.0.2416 (9.0.2911.0)
Importance: Normal
X-MimeOLE: Produced by Microsoft MimeOLE V6.00.2800.1478
This is a multi-part message in MIME format.
------= NextPart_000_046B_01C5D0D5.04A87ED0
Content-Type: text/plain;
  charset=“utf-8”
Content-Transfer-Encoding: quoted-printable
TST EMAIL BODY
EOF
-------=_NextPart_000_046B_01C5D0D5.04A87ED0
Content-Type: text/plain;
  name=“test.txt”
Content-Transfer-Encoding: 7bit
Content-Disposition: attachment;
  filename=“test.txt”
This is A TEST DOCUMENT.
END
-------_NextPart_000_046B_01C5D0D5.04A87ED0--
```

In some embodiments, the portion identifier 304 identifies different portions of the email message based on the text and/or the pattern of text as it appears in the message. In this example, the portion identifier 304 identifies the boundary string as:

“------=NextPart_000 046B 01C5D0D5.04A87ED0”,

the body header as:

Content-Type: text/plain;

charset=“utf-8”

Content-Transfer-Encoding: quoted-printable

the body data as:

TEST EMAIL BODY
EOF

the attachment header as:

Content-Type: text/plain;

name=“test.txt”

Content-Transfer-Encoding: 7bit
Content-Disposition: attachment;

filename=“test.txt”

and the attachment body data as:

This is A TEST DOCUMENT.
END

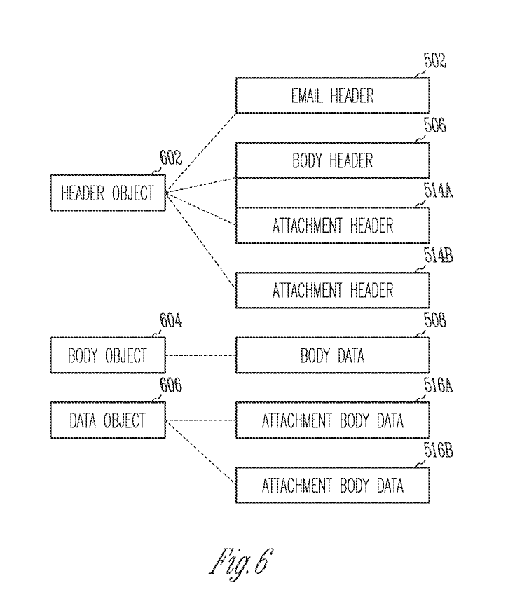

Next, the object assigning module 306 associates the portion of the email data identified in step 404 with an object (Step 406). In the illustrated embodiments, the module 302 is configured to associate an identified email portion with a header object, a body object, or a data object, each of which is data abstraction for allowing data associated therewith to be processed in an object-based configuration. As shown in FIG. 6, identified email header 502, body header 506, and attachment header 514a, 514b are associated with header object 602, the email body data 508 is associated with a body object 604, and the attachment body data 516a, 516b are associated with data object 606. In other embodiments, instead of the three objects 602, 604, 606, the module 302 can be configured to associate email portions with less than or more than three objects. Also, in further embodiments, instead of, or in addition to, the objects 602-606, module 302 can be configured to associate different data portions with other data objects.

Also, in other embodiments, an object can have one or more sub-objects associated therewith. For example, in other embodiments, the data object 606 can itself be another collection of objects such as header objects, body objects and data objects, wherein the data objects may represent some text data, data from a picture file, or other types of data. This may recursively continue with other sub-objects containing collections of objects and is commonly known as nesting. Having sub-object(s) associated with an object allows data represented by the object to be further categorized, thereby creating another level of granularity.

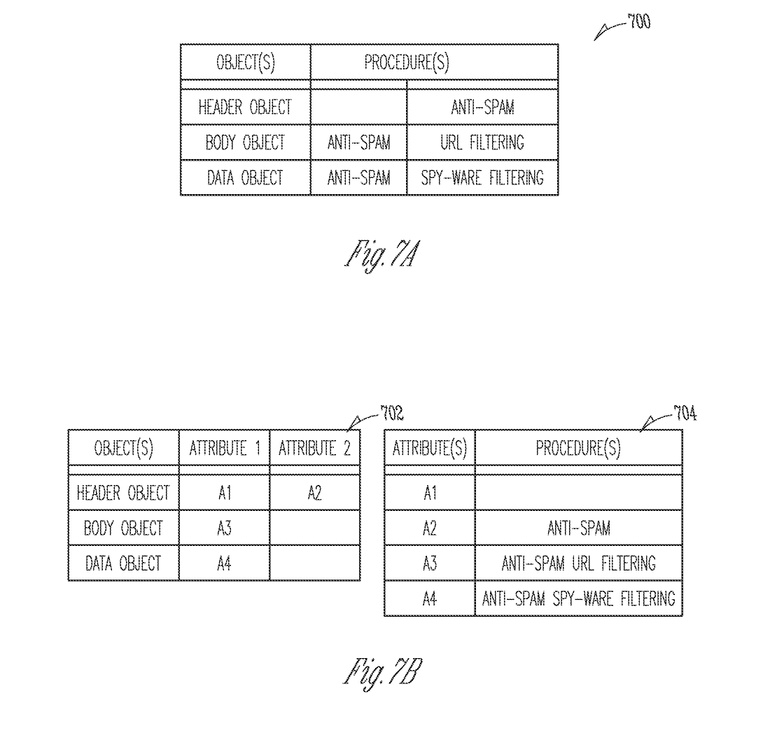

Next, the procedure assigning module 308 assigns one or more procedures for the identified portion based on the object representing the identified portion (Step 408). FIG. 7A illustrates a procedure assignment table 700 that can be used by the procedure assigning module 308 to assign procedure(s) in accordance with some embodiments. The table 700 can be stored in a medium in module 302, or in a server or storage that is accessible by the module 302. As shown in the table 700, data associated with the header object 602 will be processed by an anti-spam procedure, data associated with the body object 604 will be processed by an anti-spam procedure and an URL filtering procedure, and data associated with the data object 606 will be processed by an anti-spam procedure and a spy-ware filtering procedure. In further embodiments, instead of that shown in the example of FIG. 7A, more than two procedures can be assigned to each object.

In other embodiments, each of the objects 602, 604, 606 can include one or more attributes, based on which, one or more procedures can be assigned by the procedure assigning module 308. For example, as shown in the example of attribute table 702 in FIG. 7B, the header object 602 can have attributes A1, A2, the body object 604 can have attribute A3, and the data object 606 can have attribute A4. In such cases, the procedure assigning module 308 can assign one or more procedures based on the attribute(s) of each object. For example, the procedure assigning module 308 can use a procedure assignment table 704, which prescribes one or more procedures based on different attributes of the objects. In the illustrated example, an object having attribute A1 will not be assigned any procedure, an object having attribute A2 will be assigned an anti-spam procedure, an object having attribute A3 will be assigned an anti-spam procedure and an URL filtering procedure, and an object having attribute A4 will be assigned an anti-spam procedure and a spy-ware filtering procedure. Tables 702, 704 can be stored in a medium associated with module 302, or in a server or storage that is accessible by the module 302.

It should be noted that the number of attributes associated with an object is not limited to two, and that an object can have more (e.g., ten) or less (e.g., zero) than two attributes in other embodiments. Also, two different objects can have the same attribute in some embodiments.

In some embodiments, if an object contains sub-objects, the sub-objects can be further identified and assigned appropriate procedure(s) that are more specific for the type of sub-object. For example, suppose an object represents an attachment body and this attachment body contains within it a collection of objects including a header object, body object, attachment header object and an attachment or data object. Instead of treating the object as one complete object it can be separated into these sub-objects and each sub-object can be assigned procedure(s). If the sub-object representing the data object is a binary executable file, for example, then appropriate binary processing procedure(s) can be assigned.

After the procedure assigning module 308 assigns the procedure(s), the processor 310 then processes the identified portion of the email data in accordance with the assigned procedure(s).

As shown in the above embodiments, scanning electronic data using an object-oriented based procedure allows procedure(s} to be assigned efficiently.

In some embodiments, the modules 306-310 can be implemented as a filtering module that may include different filters (routines or sets of routines). One or more filters may be associated with a particular object or multiple objects. When a particular object is sent to the filtering module, the filter(s) associated with that particular type of object is triggered, and runs its filtering algorithms upon the data associated with the object. If more than one filter is associated with an object, the filters can be triggered, either sequentially or in parallel.

One type of filter may be an anti-virus scanning filter. This filter is triggered by the decoded attachment body object or main body object (or a decoded portion from within the main body object). In some embodiments, the anti-virus filter examines the data and attempts to determine the type of file the data represents (e.g. a word file, a windows executable, etc.). Once the type of file is determined, then an appropriate set of virus signatures will be searched for in the file. In some embodiments, if no virus is found by these signatures then a final set of signatures (non-data-type dependent signatures) is checked against the file as a final check. This last set of signatures will be compared against any data that is examined by the antivirus scanning filter whether it was successfully file typed or whether it is treated as some raw data. The last set of signatures can be used to potentially catch unknown or new variants of a virus that were undetected by the type specific signatures.

Other filters include spam filters which can be triggered based on the header of the email (e.g., by examining the subject, from and to header fields, and other fields), and filename blocking filters which can be triggered based on the attachment header objects to search for the filename of the attached file and determine if the file should be blocked. Other types of filters known in the art may also be used.

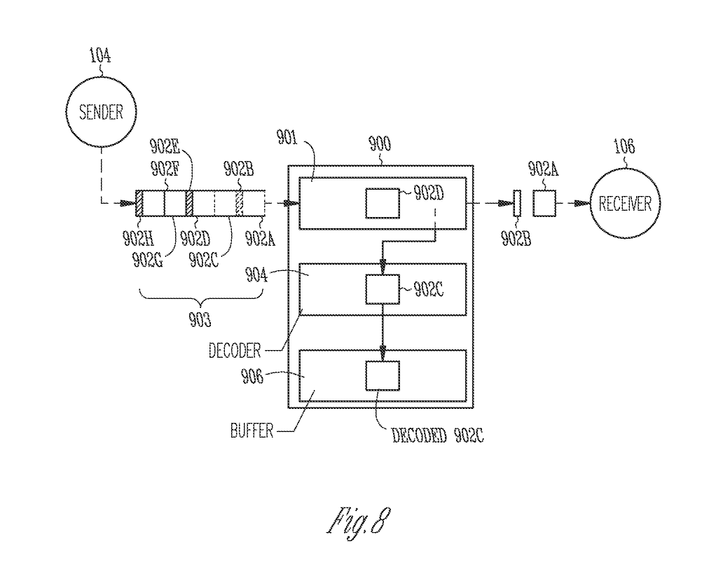

FIG. 8 is a block diagram illustrating how email data is passed from the sender 104 to the receiver 106 through module 900 in accordance with some embodiments. In some embodiments, the module 900 can be any of the modules 102, 302 described herein. In other embodiments, the module 900 can be other modules having processing capabilities. As shown in the figure, a transport buffer 901 of the module 900 receives email data 903, which in the example, includes electronic data portions 902a-902h. The transport buffer 901 allows data proxying between a client and a server. In other embodiments, the transport buffer 901 is not a component of the module 900, but is instead, coupled to the module 900. In such cases, the transport buffer 901 may be a component of a proxy module that is coupled to module 900. After the MIME message 903 is received, or as portion(s) of the email data 903 is being received, module 900 identifies portions 902 of email data 903 in accordance with embodiments described herein. In some embodiments, if a portion is determined as a header 902a, module 900 then passes the header 902a downstream towards the receiver 106 without processing the header 902a. Also, in some embodiments, if a portion is determined as a delimiter (e.g., portions 902b or 902e), module 900 then passes the delimiter downstream towards the receiver 106 without processing the delimiter.

For each portion of the email data that has been identified, the portion is then transmitted to a decoder 904 which decodes the portion, and passes the decoded portion to a working (or processing) buffer 906. For example, each identified portion can be represented by (or associated with) an object, and the portion is then passed to the decoder 904 based on the object.

At the working buffer 906, one or more procedures are performed on the decoded portion. For example, in some embodiments, if the module 900 includes the procedure assigning module 306 described previously, the procedure assigning module 306 can assign one or more procedures to process the decoded portion based on an object associated with the decoded portion. In some cases, the buffer 906 allows the data object 902 stored therein to be processed by multiple parallel procedures, such as virus scanning and content filtering. By carrying out the procedures in parallel (simultaneously), the data object 902 can be scanned more efficiently, as compared to performing the procedures in sequence (one after the other). In some embodiments, the decoder 904 and/or the working buffer 906 can be components of the processing module 310, or components of a processing unit.

In the illustrated embodiments, the decoder 904 is configured to pass a decoded portion (portion 902c in the example) to the working buffer 906 after a previous decoded portion (portion 902a in the example) in the buffer 906 has been processed. As such, the working buffer 906 is configured to store one decoded portion at any point in time. Such arrangement has the benefit of saving memory/storage space at the working buffer 906, and obviates the need to keep track with multiple objects in the buffer 906.

After the data portion has been processed, the data portion is then passed downstream towards the receiver 106 if it is determined not to contain any malicious content. In the illustrated embodiments, the module 900 is configured to pass each portion 902 downstream after the portion 902 is processed. As shown in the figure, portions 902a and 902b have been passed downstream, with decoded portion 902c being processed in the buffer 906. In other embodiments, the module 900 retains all of the processed portions 902, and sends the entire email 903 after all of the portions 902 have been processed.

If any portion of the email data is determined to contain malicious content, or as having a possibility of containing malicious content, the portion is not transmitted to the receiver 106. In some embodiments, the remaining portions of the email data can still be passed to the receiver 106, provided that they do not contain any malicious content. In other embodiments, the remaining portions of the email data are not passed to the receiver 106 if any portion of the email data contains, or is suspected of containing, malicious content.

Although the module 900 is described as having one working buffer 906, in other embodiments, the module 900 can have more than one working buffers 906. In such cases, each of the working buffers 906 can hold a different object for processing. In some embodiments, each of the buffers 906 (or a subset of the buffers 906) in the module 900 holds one object at a point in time, wherein the objects held by the buffers 906 are associated with a common email (or encapsulation). In other embodiments, each of the buffers 906 (or a subset of the buffers 906) holds one object at a point in time, wherein the objects held by the buffers 906 are each from a different email (or encapsulation). In addition, although the above embodiments have been described with reference to email data, in other embodiments, the module 900 can be configured to process data associated with other data encapsulation, such as a web page (which may encapsulate a picture, a text, a page header, etc.), a voicemail or a peer-to-peer communication.

Computer Architecture

Any of the modules described herein, or any of the components of the modules described herein, can be implemented using a computer, or a portion of a computer. For example, one or more instructions can be imported into a computer to enable the computer to perform any of the functions described herein.

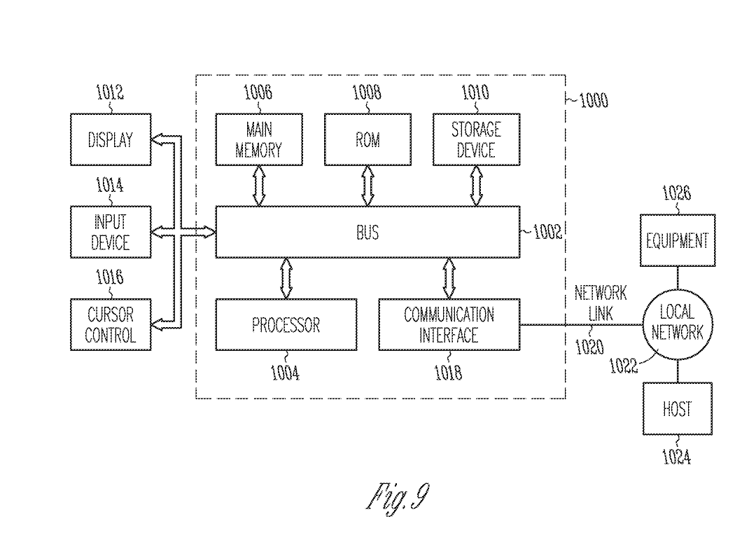

FIG. 9 is a block diagram that illustrates an embodiment of a computer system 1000 upon which embodiments of a module, or a component of a module, may be implemented. Computer system 1000 includes a bus 1002 or other communication mechanism for communicating information, and a processor 1004 coupled with bus 1002 for processing information. Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Computer system 1000 may further include a read only memory (ROM) 1008 or other static storage device(s) coupled to bus 1002 for storing static information and instructions for processor 1004. A data storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a user. An input device 1014, including alphanumeric and other keys, is coupled to bus 1002 for communicating information and command selections to processor 1004. Another type of user input device is cursor control 1016, such as a mouse, a trackball, cursor direction keys, or the like, for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Embodiments described herein are related to the use of computer system 1000 for transmitting, receiving, and/or processing electronic data. According to some embodiments, such use may be provided by computer system 1000 in response to processor 1004 executing one or more sequences of one or more instructions contained in the main memory 1006. Such instructions may be read into main memory 1006 from another computer-readable medium, such as storage device 1010. Execution of the sequences of instructions contained in main memory 1006 causes processor 1004 to perform the steps described herein. One or more processors in a multi-processing arrangement may also be employed to execute the sequences of instructions contained in main memory 1006. In alternative embodiments, hard-wired circuitry may be used in place of or in combination with software instructions to implement various operations/functions described herein. Thus, embodiments are not limited to any specific combination of hardware circuitry and software.

The term “computer-readable medium” as used herein refers to any medium that participates in providing instructions to processor 1004 for execution. Such a medium may take many forms, including but not limited to, non-volatile media, volatile media, and transmission media. Non-volatile media includes, for example, optical or magnetic disks, such as storage device 1010. Volatile media includes dynamic memory, such as main memory 1006. Transmission media includes coaxial cables, copper wire and fiber optics, including the wires that comprise bus 1002. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 1004 for execution. For example, the instructions may initially be carried on a magnetic disk of a remote computer. The remote computer can load the instructions into its dynamic memory and send the instructions over a telephone line using a modem. A modem local to computer system 1000 can receive the data on the telephone line and use an infrared transmitter to convert the data to an infrared signal. An infrared detector coupled to bus 1002 can receive the data carried in the infrared signal and place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry data streams representing various types of information.

Network link 1020 typically provides data communication through one or more networks to other devices. For example, network link 1020 may provide a connection through local network 1022 to a host computer 1024. Network link 1020 may also transmits data between an equipment 1026 and communication interface 1018. The data streams transported over the network link 1020 can comprise electrical, electromagnetic or optical signals. The signals through the various networks and the signals on network link 1020 and through communication interface 1018, which carry data to and from computer system 1000, are exemplary forms of carrier waves transporting the information. Computer system 1000 can send messages and receive data, including program code, through the network(s), network link 1020, and communication interface 1018. Although one network link 1020 is shown, in alternative embodiments, communication interface 1018 can provide coupling to a plurality of network links, each of which connected to one or more local networks. In some embodiments, computer system 1000 may receive data from one network, and transmit the data to another network. Computer system 1000 may process and/or modify the data before transmitting it to another network.

Although particular embodiments have been shown and described, it will be understood that it is not intended to limit the present inventions to the embodiments, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed is:

1. A method of processing encapsulation data, comprising:
receiving encapsulation data;
identifying a first portion of the encapsulation data;
sending the first portion to a buffer for processing; and
sending a second portion to the buffer for processing after the first portion has been processed.

2. The method of claim 1, further comprising:
identifying a header in the encapsulation data; and
passing the header without processing the header.

3. The method of claim 1, wherein the first portion is selected from the group consisting of an email header, an email body, and an attachment.

4. The method of claim 1, further comprising assigning a first procedure to scan the first portion for content desired to be detected, wherein the first procedure is assigned based on an object representing the first portion.

5. The method of claim 4, wherein the object is selected from the group consisting of a header object, a body object, and a data object.

6. The method of claim 1, further comprising scanning the first portion against a signature that is not data-type dependent.

7. A computer-program product having a medium, the medium having a set of instructions executable by a processor, wherein execution of the instructions by the processor causes a method to be performed, the method comprising:
receiving encapsulation data;
identifying a first portion of the encapsulation data;
sending the first portion to a buffer for processing; and
sending a second portion to the buffer for processing after the first portion has been processed.

8. The computer-program product of claim 7, the method further comprising:
identifying a header in the encapsulation data; and
passing the header without processing the header.

9. The computer-program product of claim 7, wherein the first portion is selected from the group consisting of an email header, an email body, and an attachment.

10. The computer-program product of claim 7, further comprising assigning a first procedure to scan the first portion for content desired to be detected, wherein the first procedure is assigned based on an object representing the first portion.

11. The computer-program product of claim 10, wherein the object is selected from the group consisting of a header object, a body object, and a data object.

12. The computer-program product of claim 7, further comprising scanning the first portion against a signature that is not data-type dependent.

13. A method of processing electronic data, comprising:
receiving electronic data to be scanned;
identifying a portion of the electronic data, wherein the portion is represented as an object; and
assigning one or more procedures to scan the portion based at least in part on the object.

14. The method of claim 13, wherein the one or more procedures is assigned based on an attribute of the object.

15. The method of claim 13, wherein the electronic data comprises email data.

16. The method of claim 13, wherein the typed object is selected from the group consisting of a header object, a body object, and a data object.

17. The method of claim 13, wherein the portion is selected from the group consisting of an email header, an email body, and an attachment.

18. The method of claim 13, further comprising identifying a sub-portion of the portion, wherein the sub-portion is represented as an object.

19. The method of claim 18, wherein the object representing the sub-portion comprises an attachment header or attachment body data, and the object representing the portion comprises an attachment.

20. The method of claim 13, wherein the portion is identified by identifying a delimiter.
